(19) United States
(12) Patent Application Publication
(10) Pub. No.: US 2002/0090859 A1
(43) Pub. Date: Jul. 11, 2002

(54) Vertically integrated card housing

(76) Inventors: Richard Brayden, Saratoga, CA (US); William L. Densham, Los Gatos, CA (US)

Correspondence Address: Edmund Paul Pfleger, HAYES, SOLOWAY, HENNESSEY, GROSSMAN & HAGE, P.C., 130 W. Cushing Street, Tucson, AZ, 85701, US

(21) Appl. No.: 09/757,266

(22) Filed: Jan. 9, 2001

Related U.S. Application Data
(60) Provisional application No. 60/207,534, filed on May 26, 2000.

(51) Int. Cl. H01R 13/60

(52) U.S. Cl. 439/541.5

(57) ABSTRACT

An integrated card housing to house two or more PC cards is disclosed. In one embodiment, the housing includes a first slot to receive a PCMCIA card, and a second slot to receive a Smart card, stacked on one another, thereby permitting integration into a personal computer or laptop computer without requiring side-by-side slots for PCMCIA and Smart card media. The housing includes conventional I/O connectors and power connectors for each of the respective media slots.

### FIELD OF THE INVENTION

The present invention relates to a housing including a PCMCIA slot and a smart card slot for use in a personal computer. More particularly, this invention relates to a single mounting fixture consisting of a PCMCIA connector mounted on top of or below a smart card connector.

### DESCRIPTION OF RELATED ART

The Personal Computer Memory Card International Association (PCMCIA), a group of manufacturers and vendors formed to promote a common standard for PC Card-based peripherals, has introduced a standard specifying the configuration of a PC card, the dimensions of a PCMCIA slot in the housing of a computer adapted to receive a PC card, and the configuration of a female connector inside the slot which is designed to hold a male connector located on one edge of the PC card. A card of this type can be installed directly in the card slot of the computer.

The IC or “smart card” has the physical dimensions similar to the dimensions of the well-known magnetic strip bank cards and typically incorporate one or more built-in integrated circuits. Additionally, smart cards generally have built-in contact pads, connected to the built-in integrated circuit, for interacting with a smart card reader. The built-in integrated circuit can be a microprocessor and a memory, a logic circuit and a memory, or just a memory. One of the advantages of smart cards over magnetic strip cards is that smart cards can be programmed and reprogrammed and, thus, can be reused. It would be useful to use smart card in conjunction with a data processing machine such as a personal computer, for example. The PC could be used for programming or reprogramming the smart card as well as for retrieving information from the smart card. However, due to structural and functional differences between PC cards and smart cards, smart cards cannot be directly inserted into the PCMCIA slot.

Thus a special interface or adapter is required between the computer and the smart card. Presently, Smartcard passive adapters are inserted into the PCMCIA slot and then the smart card is inserted into the adapter. When providing a smart card bus in a PC, typically the manufacturer uses two separate side by side housings mounted to the printed circuit board, a single slot PCMCIA fixture and a separate smart card. This is problematic, particularly in a laptop or notebook computer, due to space limitations. Another problem with this is that separate fixtures occupy more space on the printed circuit board. It is thus desirable to interface smart cards with personal computers without adding overhead, without increasing printed circuit board area and without changing the current PC configuration.

### SUMMARY OF THE INVENTION

The present invention provides for a housing having a PCMCIA slot for receiving a PC card, and a separate slot for receiving a smart card. The housing further includes interface circuitry for transferring data between the PC, the PC card and the smart card. In the preferred embodiment, the housing comprises a single mounting fixture in direct contact with the printed circuit board, wherein the PCMCIA and smart card slots are arranged in a stacked relationship at the front of the housing, a 68 pin PCMCIA connector is mounted on top of an 8 pin smart card connector at the back of the housing, vertically integrated circuitry can also be provided between the smart card and the PC card.

Accordingly it is an object of the invention to provide a single vertical stack housing including a PCMCIA slot and a smart card slot that will fit in a laptop or notebook computer. It is another object of the invention to provide a single fixture having PCMCIA and smart card slots in direct contact with the printed circuit board, without changing the current PC configuration.

Additional benefits and advantages of the present invention will become apparent to those skilled in the art to which this invention relates from the subsequent description of the preferred embodiments and the appended claims, taken in conjunction with the accompanying drawings.

### BRIEF DESCRIPTION OF THE DRAWINGS

FIG. 1 is a front elevational view of the housing according to the present invention;

FIG. 2 is a rear elevational view of the housing according to the present invention;

FIG. 3 is a perspective view showing the front of the housing according to the present invention;

FIG. 4 is a perspective view showing the rear of the housing according to the present invention;

FIG. 5 is a side elevational view showing of the housing according to the present invention.

### DESCRIPTION OF EXEMPLARY EMBODIMENTS OF THE INVENTION

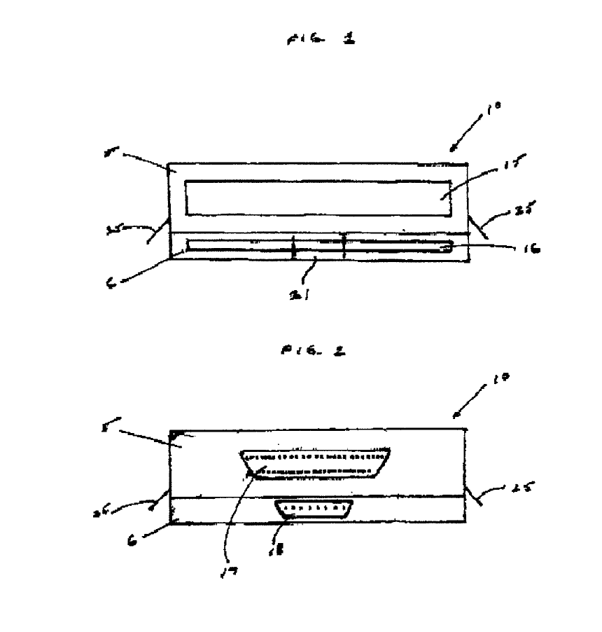

Referring to the drawings, FIGS. 1 and 3 illustrate an integrated PC and smart card housing 10 including a PCMCIA housing 5 stacked on top of smart card housing 6. The PCMCIA housing 5 includes slot 15 for receiving a PC card or the like. Similarly, the smart card housing 6 includes a slot 16 for receiving a smart card. The smart card slot 16 preferably further comprises an indentation 21 for accessing a smart card. The PCMCIA housing 5 is integral with the smart card housing 6 such that the PCMCIA slot 15 and the smart card slot 16 are arranged in stacked relationship at the front of the housing 10.

As shown in FIG. 3, the housing 10 comprises a single contact 20 configured to provide electrical power supply to the integrated housing 10. Preferably contact 20 comprises a multi-pin connection which is in direct contact with the printed circuit board (not shown). Contact 20 may be configured to provide direct contact with the printed circuit board either in the form of surface mount solder pads, or through board pins. Alternately, contact 20 may comprise a socket configured to receive a plug-type electrical coupling. Furthermore, it is contemplated herein that contact 20 may optionally be located at the rear of the housing 10. Additionally, the housing 10 further comprises mounting tabs 25 for physically securing the housing 10 to the printed circuit board, or configured for physically securing the housing within a computer. In still other alternatives, power may be supplied directly through the I/O connector, such as the PCMCIA connector, discussed below.

Turning to FIGS. 2 and 4, the rear of the housing 10 is illustrated including a 68 pin PCMCIA I/O connector 17 arranged in the back of PCMCIA housing 5 mounted on top of an 8 pin smart card I/O connector 18 similarly disposed on the back of the smart card housing 6. The PCMCIA connector 17 and smart card connector 18 are configured to be coupled with complimentarily configured plug-type connectors. Alternatively, connectors 17 and 18 need not be disposed on the back of the housing, but may instead be provided, for example, on the bottom of the housing. Additionally, power may be supplied to the respective media through connectors 17 and 18 rather than through a power connector 20 as depicted in FIG. 3.

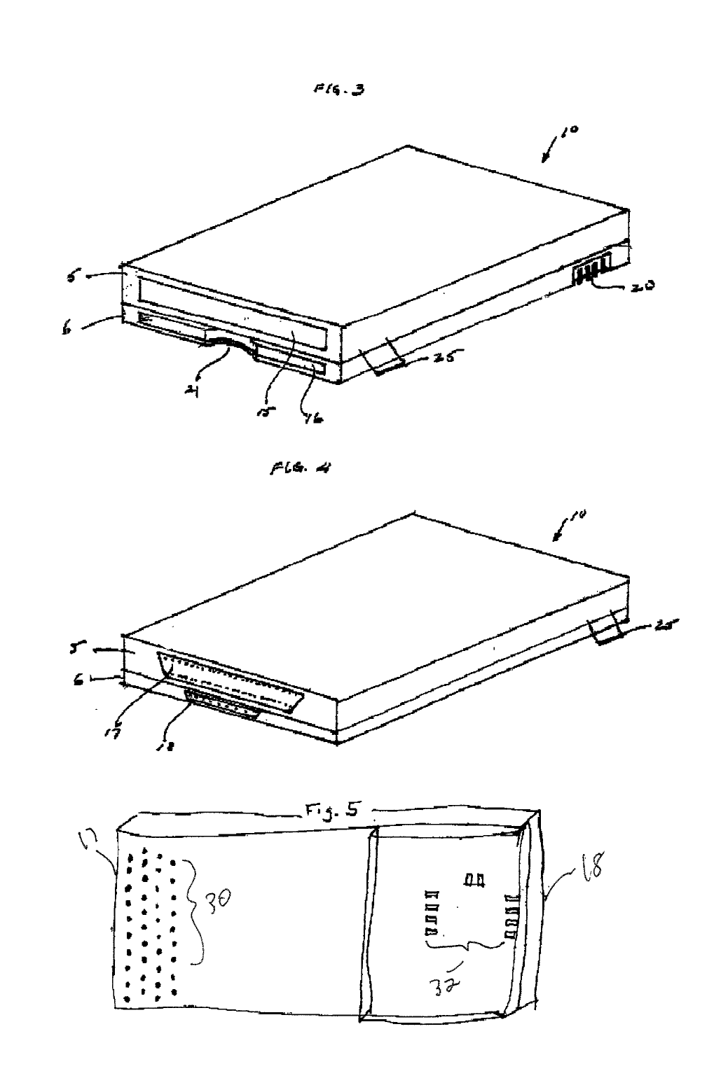

Alternately, the housing 10 may be configured to provide direct connection between the housing 10 and a printed circuit board (not shown). As illustrated in FIG. 5, the 68 pin PCMCIA connector 17 and the 8 pin smart card connector 18 may comprise surface mount solder pads 30 and 32, respectively, providing direct connection between the housing 10 and the printed circuit board. Alternately, the 68 pin PCMCIA connector 17 and the 8 pin smart card connector 18 may comprise through board pins for direct connection to the printed circuit board.

While this invention has been disclosed and illustrated with reference to particular embodiments, the principles involved are susceptible for the use in numerous other embodiments which will be apparent to persons of ordinary skill in the art. The invention is, therefore, not to be limited by the exemplary embodiments described in detail hereinabove.

What is claimed is:

1. An integrated card housing comprising:
a first slot configured to receive a PCMCIA card;
a second slot configured to receive a smart card, said first slot and said second slot being configured in a stacked arrangement;

2. The integrated card housing of claim 1, further comprising a first I/O connector coupled to said first slot for communicating with said PCMCIA card; and
a second connector I/O coupled to said second slot for communication with said smart card.

3. The integrated card housing of claim 2, wherein said first connector comprises a plurality of printed circuit board contacts.

4. The integrated card housing of claim 3, wherein said plurality of printed circuit board contacts are surface mount solder pads.

5. The integrated card housing of claim 3, wherein said plurality of printed circuit board contacts are through board pins.

6. The integrated card housing of claim 2, wherein said second connector comprises a multi-pin socket.

7. The integrated card housing of claim 2, wherein said second connector comprises a plurality of printed circuit board contacts.

8. The integrated card housing of claim 7, wherein said plurality of printed circuit board contacts are surface mount solder pads.

9. The integrated card housing of claim 7, wherein said plurality of printed circuit board contacts are through board pins.

10. The integrated card housing of claim 1, wherein said second slot comprises an indentation for accessing a smart card.

11. The integrated housing of claims 1, wherein said first slot is stacked atop said second slot.

12. The integrated housing of claims 1, wherein said second slot is stacked atop said first slot.
